(19) United States
(12) Patent Application Publication
(10) Pub. No.: US 2008/0244558 A1
(43) Pub. Date: Oct. 2, 2008

(54) CONTENT DOWNLOADING IN A RADIO COMMUNICATION NETWORK

(75) Inventor: Soren K. Lundsgaard, Inverness, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/037,959

(22) Filed: Feb. 27, 2008

Related U.S. Application Data
(60) Provisional application No. 60/908,415, filed on Mar. 28, 2007.

(51) Int. Cl. G06F 9/44

(52) U.S. Cl. 717/173

(57) ABSTRACT

A network element and method for transferring software content from a radio communication network to a network element includes associating a unique identifier for the element with the content. Content is first transferred to the element. Connectivity between the network and element is then verified. If connectivity is verified after the transfer of content, previous software content within the element is upgraded using the transferred content. Connectivity between the network and element is again verified after the upgrade. If connectivity is not verified after the transfer of the content, the previous software content is restored within the element. The connectivity tests ensure that any upgrade will not leave the network element unable to communicate with the network.

### FIELD OF THE INVENTION

The present invention relates generally to communications between application servers and network elements therein, and more particularly to methods for downloading software content to a network elements in wireless communication networks, for example in cellular communication networks.

### BACKGROUND OF THE INVENTION

The emergence of many new wireless technologies allows over-the-air programming (OATP) of software and applications of many different types of network elements in wireless communication networks. For example, the function of a terminal may be upgraded with a new revision of software. In another example, a network controller may be reprogrammed with upgraded maintenance or control software. These upgrades may include complete application software packages, changes in application software packages, data for changing operating profiles, and the like.

In any of these cases, it is important that the OATP is accomplished successfully. In the case where the OATP is not accomplished successfully, it is necessary for the device being upgraded to recover from the unsuccessful OATP, continuing its function, without interrupting service. Various techniques have been described to address this problem.

In one example, any software or configuration changes are performed manually using portable media such as a CD-ROM, flash card, USB drive, and the like. Obviously, this is labor, travel, and material intensive and therefore undesirable.

In another example, an upgrade is sent wirelessly to a terminal and is executed to upgrade the terminal. If any fault occurs in the installation, this fault may be reported to the sender, but might otherwise leave the terminal inoperable or inaccessible. This requires human intervention to resolve the issue, which is again undesirable.

In yet another example, an upgrade sent wirelessly to a device is executed to upgrade the device. The device first stores its previous revision of the software. If the upgrade fails, the device reverts to its previous revision and requests assistance from the sender. However, this example can require several separate communications to the sender of the upgrade in order to resolve the issue. These communications may include a notification of failure, request for a resend of the file, verification of the file, authentication of the sender, re-initiation of the upgrade, and the like, all of which can interrupt service or leave the device inoperable or inaccessible for a time.

Thus, a need exists to provide for upgrades of applications or data in a network device, where any failure in the upgrade does not leave the device inoperable or inaccessible. It would also be of benefit, if minimal communications can be used to accomplish the above purpose, without interrupting service.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 illustrates a wireless communication network, in accordance with the present invention; and

FIG. 2 is a flow diagram that illustrates a method, in accordance with the present invention.

### DETAILED DESCRIPTION OF THE PREFERRED EMBODIMENT

Generally, the present invention provides a method and apparatus which provides over-the-air programming (OTAP) of network elements by downloading software objects, or content, to the network element, where any failure in the upgrade does not leave the device inoperable or inaccessible. The present invention also uses minimal communications to accomplish the above purpose, without interrupting service. The content can include a software revision or upgrade. The content can also include data for altering an operating profile configuration in the network element. As described herein, the present invention is applied to a station or mobile host that administers the network element, which is required to be accessible for remote diagnostics. However, it should be recognized that the present invention is applicable to any network entity, such as a mobile terminal, access point, and the like, and is applicable for upgrading the software or memory of that entity.

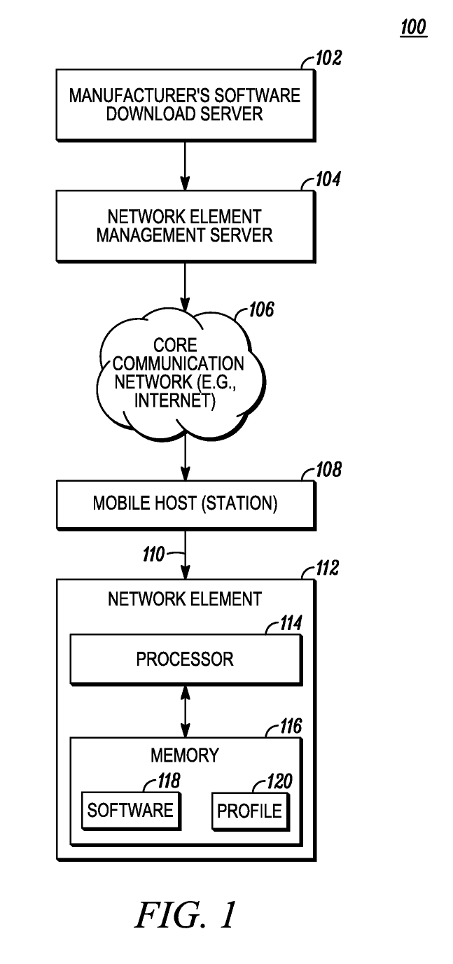

Referring to the network architecture 100 of FIG. 1, a Manufacturer's Software Download Server 102 contains a database that defines approved hardware and software content, revisions, and configurations. The download server 102 is managed for example by an equipment or software manufacturer. The database on the download server 102 may contain, for example, a unique identifier of the software type, the software version, and other indicia known in the art, which collectively identify the software uniquely and allow verification therefore. Optionally, content from the server 102 can be electronically signed by the manufacturer, thus allowing a network element 112 or network element manager 104 to process the content according to security protocols running in that device, if any.

The Manufacturer's Software Download Server 102 is made accessible by the Network Element Management Server 104, wherein identified upgraded software or content can be “pushed” to the Network Element Management Server 104 by the Manufacturer's Software Download Server 102, or requested for download from the Manufacturer's Software Download Server 102 by the Network Element Management Server 104.

The Network Element Management Server 104 communication with a mobile host or Station 108 (STA) through a core communication network 106, which can comprise wireline connections, wireless connections, Internet connections, and the like, all of which are controlled using respective protocols as are known in the art.

The Station 108 is operable to download the content over a wireless air interface 110 to one or more Network Elements 112, such as a target terminal, other network element, etc. The Network Element 112 includes a processor 114 and memory 116. The memory is used to store upgraded software 118 and/or a new profile configuration 120. The memory can also be used to store a copy of a previous revision of software and/or profile configuration to be used for restoration thereof in the case of a failure in the upgrade. The Station 108 includes an agent, such as a Wireless Device Enabler (WDE) such as the Motorola WDE 1000 or Motorola WDE 1100 manufactured by Motorola, Inc. that includes a client utility and driver, wherein the OTAP will be provisioned on the agent to provide upgrades for the Network Element 112. The processor 114 of the Network Element 112 rewrites the software 118 and/or profile configuration 120 with the respective upgraded software 118 and/or new profile configuration 120 into the memory 116.

The profile 120 can include a configurable profile, the set of parameters of which control the way the target machine 112 operates (e.g. operational band, security parameters, operation mode, etc.). The Network Element 112 is arranged to be configurable or software upgradeable using the OTAP as described herein. OTAP is required to facilitate the process of WDE software upgrades and also for profile management purposes.

In the prior art, use of the WDE to provide software upgrades required human intervention. The upgrade procedure must be conducted either at some operator facility or at the place where the target equipment is located. As for profile management, the WDE user can locally create and manage individual profiles via the client utility. The profile, in essence, determines the network element operational parameters in terms of frequency bands, security parameters, sleep mode operation characteristics, and the mode of operation (i.e. infrastructure, ad-hoc).

The present invention enables remote software upgrades and reconfiguration of profiles for the network element or target device. Using the WDE with a remote upgrade is desirable in particular for use in traffic signals and in call boxes. These network elements are geographically dispersed. As a result, maintenance of these network elements by direct connection to them would be prohibitively expensive. Similarly, connecting to the elements through the network and manually configuring these machines would be prohibitively expensive.

For example, in the field, the existing steps to manually upgrade software on a target device can include one or more of, a) determine software release contents, b) scheduling software release contents, c) determining dependency on other hardware and software products and versions, d) determining allowed previous software versions (for uninstall), e) create a software bundle, f) create installation notes, g) create CD-ROM image, h) create SMS image, i) test image(s), j) post image to manufacturer secure web site, k) create media from image(s), l) ship media to customers, m) track customer adoption. As can be realized, this is time, labor and cost prohibitive.

Using Microsoft Systems Management Server (SMS), the present invention will enable a remote administrator to update a network element with driver software and also to define new profiles and to set an active profile. SMS includes powerful methods for ensuring that updates are pushed to target machines based on appropriate criteria, as well as monitoring for faults or exceptions in this process. In conjunction with SMS, OTAP generates packages that can be installed onto SMS client computers.

For both software upgrade and profile management packages, the packages can be in the form of a “windows installer” or “SMS Installer” package, preferably compressed as a ZIP file. As such, the service would be applicable to host stations reachable by an SMS server for stations working in infrastructure mode. The packages can include upgrade versions only, i.e. it is assumed that installation package of the WDE driver, client utilities and client utility profiles are already installed on the mobile host station 108. In practice, the WDE is implemented on a hardware card located in the station. Alternatively, the WDE agent can be downloaded to a particular device in the same manner described herein for software upgrades and profiles. It should be recognized that the present invention is applicable for downloading any content for any purpose.

Preferably, a download of the package shall be initiated only when a communication channel of the network element is idle. In case the where the download process is interrupted for any reason, the MS-SMS is capable of detecting this event and to follow procedures known in the art to correct the situation.

In accordance with the present invention, content packages are modified by the management server 104 to include a connectivity IP address to be used to verify network connectivity. Connectivity to the configured connectivity IP address shall be attempted at the beginning of the installation of the package. Typically, this test is just an IP “ping” of the target device, requiring minimal communication, and is sufficient to determine that the network element is connected and able to receive content, thereby defining connectivity. However, the present invention envisions that any other test for connectivity can be used that demonstrates some minimal (necessary) communication functionality of the network element. If the connectivity test determines that the IP address cannot be reached or receives no response, installation of the package shall terminate, with no changes. Preferably, the connectivity test also includes a timer, wherein if the timer expires before connectivity is established, installation of the package shall terminate, with no changes.

In addition, a connectivity test to the connectivity IP address shall be attempted at the end of the installation of the package. If the connectivity IP address cannot be reached, the downloaded package shall be uninstalled, and the machine shall revert to the state before the installation was attempted. Preferably, this connectivity test also includes another timer, which may be different from the first timer, wherein if the timer expires before connectivity is established, installation of the package shall terminate, with no changes.

The rule for connectivity can include any number of IP addresses and in addition, be defined as a reachability of specific ports at those IP addresses. It should be noted that an IP address of a network element can change during installation. The connectivity IP address in the control center is that of the target network element of the connectivity check, and this address, for all of the connectivity verification tests, should be the same before and after installation. The ruleset for successful connectivity check could be very specific, including the ability to perform some non-trivial functionality, but a novel aspect of the present invention is that a connectivity failure before the download causes the procedure to stop at that point, and a connectivity failure after the download causes the procedure to back out, i.e. restoring the network element to the state before the procedure started. The test for connectivity can be simple or can be complex, but there is only one test verification procedure, and it runs on the target network element twice—once to verify that it is an appropriate check that works before the package installation (210) and assures some necessary level of connectivity, and again after the package installation (214) to ensure that that same level of connectivity has been maintained during installation of the upgrading package.

The downloaded package can be automatically unzipped and executed by the receiving network element. The upgrade software package can be installed immediately after connectivity is verified. Alternatively, the upgrade software package can be installed as soon as the download process is completed and regardless of the current state of the station or network element.

In profile management where a new profile is downloaded to the network element, a central office management server can add an interlock to the installation to prevent the installation or activation from occurring during periods when interruptions are not advisable. This is provided so that an interrupted installation of software or configuration data does not make further communication to the network element impossible. The status of the upgrade can be reported to a control center, with such status indications as an interrupt, a failure, or a successful upgrade.

For network elements that have multiple operating states (such as multiple profiles), the connectivity test can be specified for a specific one of those operating states. This is provided so that implementation of a particular operational state of software or configuration data does not make further communication to the network element impossible.

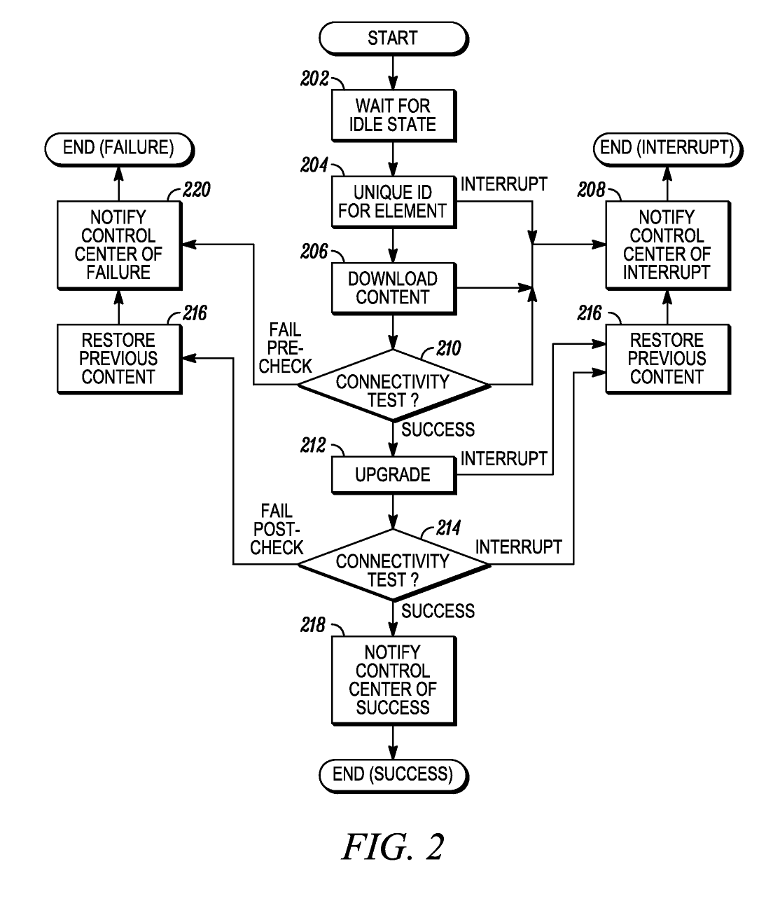

FIG. 2 provides a flow diagram for a method of transferring software content from a radio communication network to a network element, in accordance with the present invention. A first step is waiting 202 for the network element (e.g. station, mobile host, etc.) to be in an idle state, i.e. not in a communication. This helps prevent the chance of service interruption.

A next step includes associating 204 a unique connectivity identifier for the target network element with the content. In practice, the unique connectivity identifier can be an Internet Protocol (IP) address of the network element. If there is an interruption in this step preventing the association of a unique connectivity identifier, a control center is notified 208 of the interrupt by an interrupt code and the method ends, due to the interrupt.

A next step includes transferring the software upgrade and/or profile configuration by downloading 206 the content from the network or a host to the target network element. If there is an interruption in this step preventing the download, the control center is notified 208 of the interrupt by an interrupt code and the method ends, due to the interrupt. Optionally, this step includes at least one of the substeps of; detecting a delivery failure, recovering from a delivery failure, and certifying delivery of the software content.

A next step includes verifying 210 connectivity between the network and the target network element after the transfer of the content. Typically, this test is just an IP “ping” of the target network element, requiring minimal communication, and is sufficient to determine that the network element is connected and able to receive content from the network, thereby defining connectivity. It should be noted that the transferring step 206 and verifying step 210 can be transposed in the present invention, where the connectivity verification step comes before the whole package download. However, in this event, there is an increase in the time between the two connectivity tests 210, 214. With this increase in time, the network element may change its location, wherein the first test 210 would succeed, but the second test 214 would fail because the network element was out of range, causing a false negative in the second connectivity verification test.

If there is an interruption in this verifying step 210 preventing verifying connectivity, the control center is notified 208 of the interrupt by an interrupt code and the method ends, due to the interrupt. If the result of the connectivity test demonstrates that there is not connectivity (fail pre-check), within a predetermined time, a control center is notified 220 of the failure by a failure code and the method ends to be repeated at a later time. However, if the result of the connectivity test demonstrates that there is connectivity (pre-check success), the method can proceed.

A next step includes upgrading 212 the previous software content within the network element using the transferred software content. This can include storing the previous software/profile, upgrading the software and/or managing the profile and replacing it in memory with the upgraded version. Optionally, the upgrade is performed immediately upon successful transfer of the content in the transferring step 206 to save further time. If there is an interruption in the upgrade, the previous content is restored 216, control center is notified 208 of the interrupt by an interrupt code, and the method ends.

A next step includes verifying 214 connectivity between the target network element and network using the connectivity IP address after the upgrade. If there is an interruption in this verifying step 214 preventing verifying connectivity, the previous content is restored 216, the control center is notified 208 of the interrupt by an interrupt code and the method ends, due to the interrupt. If connectivity is not verified (fail post-check) between the network and the network element within a predetermined time, the previous software content and previous state within the network element is restored 216, the control center is notified 220 of the failure by a failure code and the method ends, due to the failure. However, if the result of the connectivity test demonstrates that there is connectivity (post-check success), a control center is notified 218 of the successful upgrade and the method ends in success.

The connectivity tests 210, 214 both before and after the upgrade provide an indication that connectivity is verified between the network and network element during the upgrading and that the upgrade was successful. Preferably, both connectivity tests 210, 214 are performed by the network element. It should be noted that the timers used in the connectivity tests 210 and 214 can have different times. It should be further noted that these timers can be repeated one or more times according to network rules.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method of transferring software content from a radio communication network to a network element, the method comprising the steps of:
transferring the content from the network to the network element;
upgrading previous software content within the element using the transferred software content if connectivity between the network and network element is verified during the upgrading, wherein
if connectivity is not verified between the network and the network element after upgrading, restoring the previous software content within the network element.

2. The method of claim 1, further comprising the step of restoring the previous software content within the network element if the upgrading step is interrupted.

3. The method of claim 1, wherein the transferring step includes certifying delivery of the software content.

4. The method of claim 1, further comprising the step of associating a unique connectivity identifier for the network element with the content, and wherein the connectivity steps verify connectivity using that unique connectivity identifier.

5. The method of claim 4, wherein the unique connectivity identifier is an Internet Protocol (IP) address.

6. The method of claim 1, further comprising the step of notifying a control center with the results of the connectivity verification.

7. The method of claim 1, wherein for a network element having multiple operating states, the connectivity verification is specified for a specific one of those operating states.

8. The method of claim 1, wherein the steps are performed when the network element is otherwise idle.

9. A method of transferring software content from a radio communication network to a network element, the method comprising the steps of:
associating a unique connectivity identifier for the network element with the content;
transferring the content from the network to the network element;
verifying connectivity between the network and the unique connectivity identifier of the network element;
if connectivity is verified between the network and the unique identifier for the network element after the transfer of the content;
upgrading previous software content within the network element using the transferred software content;
verifying connectivity between the network and the unique connectivity identifier for the network element after the upgrading, wherein
if connectivity is not verified between the network and the unique connectivity identifier for the network element after upgrading, restoring the previous software content within the network element.

10. The method of claim 9 wherein the transferring step includes at least one of the substeps of recovering from a delivery failure and certifying delivery of the software content.

11. The method of claim 9, wherein the unique connectivity identifier is an Internet Protocol (IP) address.

12. The method of claim 11, wherein for a network element having multiple operating states, the connectivity steps are specified for a specific one of those operating states.

13. The method of claim 9, wherein the content in the upgrading step is used in the network element for at least one of the group of upgrading software and managing a profile.

14. The method of claim 9, wherein the upgrading step includes upgrading immediately upon successful transfer of the content.

15. A network element for implementing a transfer of software content from a radio communication network, the network element comprising:
a memory for storing previous software content; and
a processor that receives content transferred from the network, verifies connectivity to the network, wherein if connectivity to the network is verified after the transfer of the content the processor upgrades the previous software content in the memory using the transferred software content, and verifies connectivity to the network after the upgrade, wherein if connectivity is not verified to the network after the upgrade, the processor restores the previous software content in the memory.

16. The network element of claim 15, wherein the processor verifies connectivity by to the network using a unique connectivity identifier for the network element.

17. The network element of claim 15, wherein the processor restores the previous software content within the memory if the upgrade or connectivity test after the upgrade are interrupted.

18. The network element of claim 15, wherein the processor further notifies a control center with the results of the connectivity test after upgrade.

19. The network element of claim 15, wherein for a network element having multiple operating states, the connectivity tests are specified for a specific one of those operating states.

20. The network element of claim 15, wherein the processor also certifies delivery of the transferred content with the network.
